(19) United States
(12) Patent Application Publication
(10) Pub. No.: US 2016/0252852 A1
(43) Pub. Date: Sep. 1, 2016

(54) IMAGE FORMING APPARATUS

(71) Applicant: KYOCERA Document Solutions Inc., Osaka (JP)

(72) Inventor: Kazuhiro NAKACHI, Osaka (JP)

(73) Assignee: KYOCERA Document Solutions Inc., Osaka (JP)

(21) Appl. No.: 15/054,365

(22) Filed: Feb. 26, 2016

(30) Foreign Application Priority Data
Feb. 27, 2015 (JP) 2015-039209

(51) Int. Cl. G03G 15/20; G03G 15/00

(52) U.S. Cl. CPC G03G 15/205

(57) ABSTRACT

An image forming apparatus includes an image forming unit, a fixing unit, a warming heater that heats a photoconductor drum, a fixing heater driving unit that turns a fixing heater on and off, a warming heater driving unit that turns the warming heater on and off, a mode transition unit that shifts an image forming operation mode, in which the image forming unit performs an image forming operation, to a sleep mode when a first period has elapsed after the image forming operation mode is finished, and a processor that turns off the fixing heater when the first period has elapsed after the image forming operation mode is finished and turns on the warming heater when a second period longer than the first period has elapsed after the image forming operation mode is finished.

### INCORPORATION BY REFERENCE

This application claims priority to Japanese Patent Application No. 2015-039209 filed on Feb. 27, 2015, the entire contents of which are incorporated by reference herein.

### BACKGROUND

The present disclosure relates to an image forming apparatus including a fixing device to fix a toner image formed on a recording medium, such as a multifunction peripheral, a copier, and a printer.

When the image forming apparatus is used in a high-temperature and high-humidity environment, photoconductor drums have to be frequently refreshed in order to prevent dew condensation on the surface of the photoconductor drums, and therefore the first copy time (time after the copy start button is pressed and until the trailing edge of a first sheet is discharged to a tray) may become longer than the specification of the product. Accordingly, a warming heater is employed so as maintain the surface temperature of the photoconductor drum, for the purpose of preventing dew condensation on the surface of the photoconductor drum.

For example, an image forming apparatus A has been proposed that includes a fixing unit that fixes a toner image on a recording sheet, a heater provided inside the fixing unit, and an environment decision device that decides whether the image forming apparatus is in an environment where dew condensation is likely to take place. The heater is activated in the environment where dew condensation is likely to take place, to thereby heat the photoconductor drums and developing units in the image forming apparatus. In the image forming apparatus A, the heater is activated irrespective of whether the image forming apparatus is in a job mode for fixing the toner image on the recording sheet or in a standby mode in which the fixing job is not performed.

In addition, an image forming apparatus B has also been proposed, configured to perform on/off control of power supply to a warming heater in the photoconductor drum, on the basis of absolute moisture content calculated from environment detection information.

### SUMMARY

Accordingly, the disclosure proposes further improvement of the foregoing technique.

In an aspect, the disclosure provides an image forming apparatus including an image forming unit, a fixing unit, a warming heater, a fixing heater driving unit, a warming heater driving unit, and a processor.

The image forming unit includes a photosensitive body, and is configured to transfer a toner image developed from an electrostatic latent image formed on the photosensitive body on a basis of image data, and form an image on a recording sheet.

The fixing unit includes a fixing heater, and is located at a position downstream of the photosensitive body in a transport direction of the recording sheet so as to heat the photosensitive body with a fixing roller to which the fixing heater supplies heat, and configured to heat the toner image thereby fixing the toner image on the recording sheet.

The warming heater heats the photosensitive body.

The fixing heater driving unit turns the fixing heater on and off.

The warming heater driving unit turns the warming heater on and off.

The processor is configured to (i) control the fixing heater driving unit so as to turn off the fixing heater when a predetermined first period has elapsed after an image forming operation mode is finished, the image forming operation mode including causing the image forming unit to perform an image forming operation while the warming heater is turned off by the warming heater driving unit and the fixing heater is turned on by the fixing heater driving unit so as to heat the fixing roller, and (ii) control the warming heater driving unit so as to turn on the warming heater when a predetermined second period longer than the first period has elapsed after the image forming operation mode is finished.

### BRIEF DESCRIPTION OF THE DRAWINGS

FIG. 1 is a front cross-sectional view showing a configuration of an image forming apparatus according to an embodiment of the disclosure;

FIG. 2 is a schematic cross-sectional view of a fixing unit;

FIG. 3 is a functional block diagram showing an electrical configuration of the image forming apparatus;

FIG. 4 is a functional block diagram showing an essential part of the internal configuration of the image forming apparatus;

FIG. 5 is a table showing a relationship between on/off states of an Eco Fuser function of the image forming apparatus and on/off control of a warming heater;

FIG. 6 is a timing chart showing a relationship among a surface temperature of a heating roller, a surface temperature of a photoconductor drum, and time; and

FIG. 7 is a flowchart showing on/off switching operations for supplying power to the warming heater, in the image forming apparatus.

### DETAILED DESCRIPTION

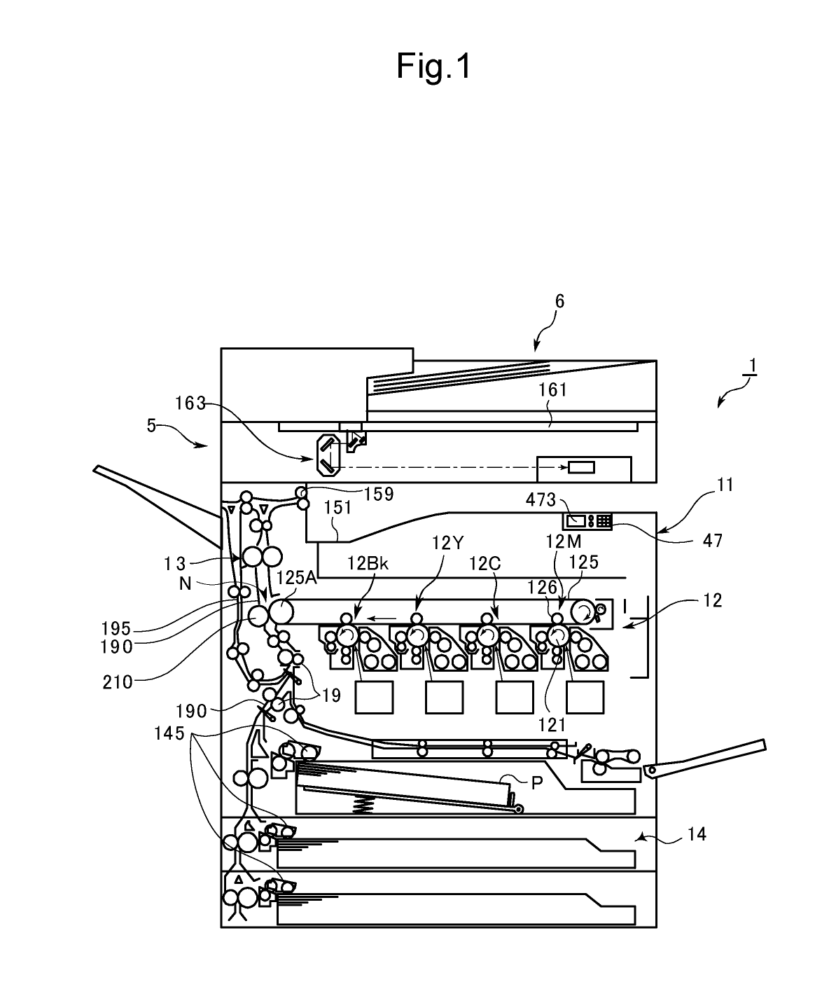

Hereafter, an image forming apparatus according to an embodiment of the disclosure will be described with reference to the drawings. FIG. 1 is a front cross-sectional view showing a configuration of the image forming apparatus according to the embodiment of the disclosure.

The image forming apparatus 1 according to the first embodiment of the disclosure is a multifunction peripheral having a plurality of functions, such as copying, printing, scanning, and facsimile transmission. The image forming apparatus 1 includes an operation unit 47, an image forming unit 12, a fixing unit (fuser unit) 13, a paper feed unit 14, a document feeder 6, and a document reader 5, which are mounted inside a main body 11.

The operation unit 47 receives instructions from the user, for operations and processes that the image forming apparatus 1 is configured to perform, such as image forming and document reading. The operation unit 47 includes a display unit 473 for displaying a guidance and so forth to the operator.

When the image forming apparatus 1 performs the document reading operation, the document reader 5 optically reads the image on a source document delivered from the document feeder 6 or placed on a platen glass 161, and generates image data. The image data generated by the document reader 5 is stored in a built-in HDD or a computer connected to a network.

When the image forming apparatus 1 performs the image forming operation, the image forming unit 12 forms a toner image on a recording sheet P serving as a recording medium and delivered from the paper feed unit 14, on the basis of the image data generated in the document reading operation and received from the computer connected to the network, or stored in the built-in HDD. In the case of color printing, an image forming subunit 12M for magenta, an image forming subunit 12 for cyan, an image forming subunit 12Y for yellow, and an image forming subunit 12Bk for black in the image forming unit 12 each form a toner image on a photoconductor drum 121 on the basis of the corresponding color component, through charging, exposing, and developing processes, and the toner image is transferred onto an intermediate transfer belt 125 via a primary transfer roller 126.

The toner images of the respective colors are superposed at an adjusted timing when transferred onto the intermediate transfer belt 125, so as to form a colored toner image. A secondary transfer roller 210 transfers the colored toner image formed on the surface of the intermediate transfer belt 125 onto the recording sheet P transported along a transport route 190 from the paper feed unit 14, at a nip region N of a drive roller 125A engaged with the intermediate transfer belt 125. Then the fixing unit 13 fixes the toner image on the recording sheet P by thermal pressing. The recording sheet P having the colored image formed and fixed thereon is discharged to an output tray 151.

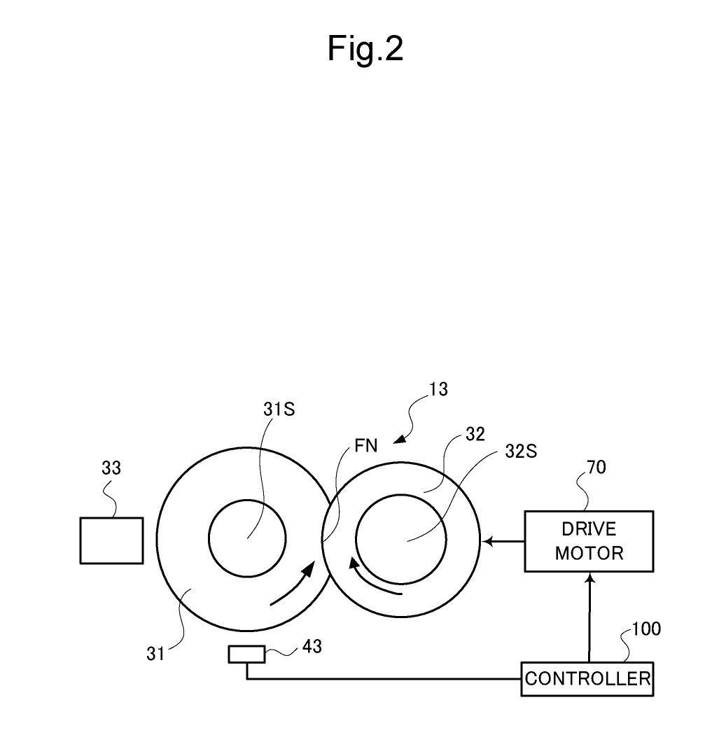

The fixing unit 13 includes an induction heating (IH) heater 33 (see FIG. 2) that serves as heat source and is located at a position downstream of the photoconductor drum 121 in a transport direction of the recording sheet P so as to heat the photoconductor drum 121, and configured to heat the toner image thereby fixing the toner image on the recording sheet P.

The paper feed unit 14 includes a plurality of paper feed cassettes. A controller 100 (see FIG. 2) rotates a pickup roller 145 of one of the paper feed cassettes in which the sheets of the size designated by the operator are placed, to thereby transport the recording sheet P in the paper feed cassette toward the nip region N.

In the case of performing duplex printing with the image forming apparatus 1, the recording sheet P having an image formed by the image forming unit 12 on one of the surfaces is nipped between a discharge roller pair 159, and then switched back by the discharge roller pair 159 to be delivered to a reverse transport route 195 and is again transported by a transport roller pair 19 to the upstream side with respect to the nip region N and the fixing unit 13 in the transport direction of the recording sheet P. Thus, the image is formed by the image forming unit 12 on the other surface of the recording sheet P.

FIG. 2 is a schematic cross-sectional view of the fixing unit 13. The fixing unit 13 includes a heating roller 31, a pressure roller 32, the IH heater 33 that heats the heating roller 31 by induction heating, a drive motor 70, and a roller temperature sensor 43.

The heating roller 31 includes a rotation shaft 31S, and the pressure roller 32 includes a rotation shaft 32S disposed parallel to the rotation shaft 31S. In this embodiment, the pressure roller 32 is a drive roller, and the heating roller 31 is the slave roller. The drive motor 70 provides rotational driving force to the rotation shaft 32S of the pressure roller 32. The pressure roller 32 is driven to rotate clockwise about the rotation shaft 32S, with the rotational driving force applied thereto, so that the heating roller 31 is caused to rotate counterclockwise. The controller 100 controls the drive motor 70 so as to control the rotation speed of the pressure roller 32, in other words the linear speed of the recording sheet passing through a fixing nip region FN.

The pressure roller 32 is pressed against the heating roller 31, and hence the circumferential surface of the heating roller 31 is abutted against the circumferential surface of the pressure roller 32. The abutment region acts as fixing nip region FN. The recording sheet P about to undergo the fixing process is nipped in the fixing nip region FN, and transported by the rotation of the heating roller 31 and the pressure roller 32 about the respective rotation shafts 31S and 32S. The recording sheet P is heat-pressed while being transported through the fixing nip region FN, thus to undergo the fixing process.

The IH heater 33 is the heat source for heating the heating roller 31. The IH heater 33 includes a coil to which a high-frequency voltage for induction heating is applied, and a magnetic core that forms a magnetic path, though both are not shown. When the high-frequency voltage is applied to the coil, the magnetic path is formed so as to pass through the heating roller 31, so that the heating roller 31 generates heat. The IH heater 33 exemplifies the fixing heater in the disclosure. Here, an electric heater such as a halogen heater may be provided inside the heating roller 31 or pressure roller 32, instead of the IH heater 33.

The roller temperature sensor 43 is opposed to the surface of the heating roller 31, and detects a surface temperature of the heating roller 31. The roller temperature sensor 43 exemplifies the fixing temperature sensor in the disclosure.

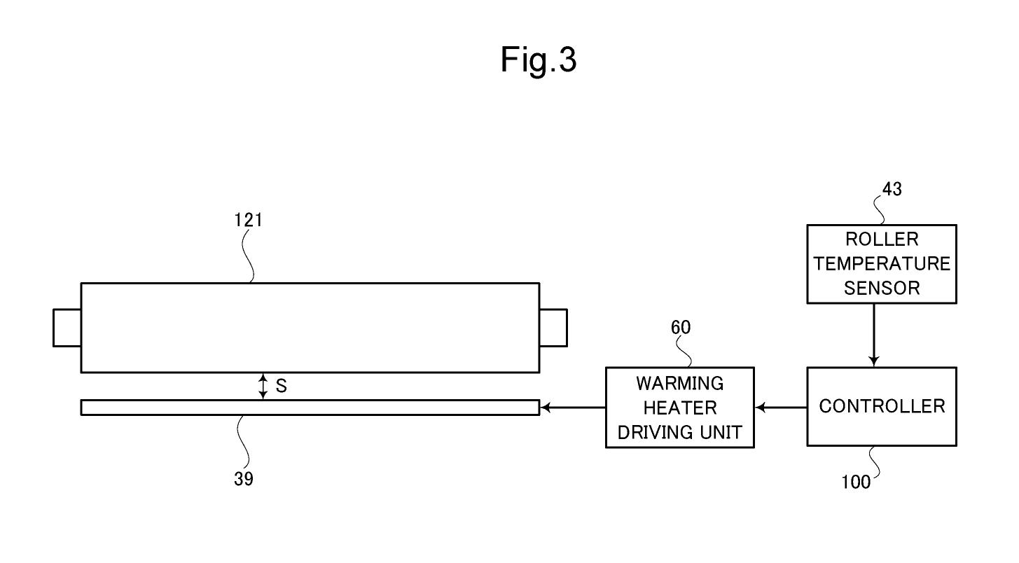

FIG. 3 is a functional block diagram showing an electrical configuration of the image forming apparatus 1. A warming heater 39 is provided adjacent to the photoconductor drum 121, with a predetermined spacing S from the surface of the photoconductor drum 121. The warming heater 39 includes, for example, a heating coil.

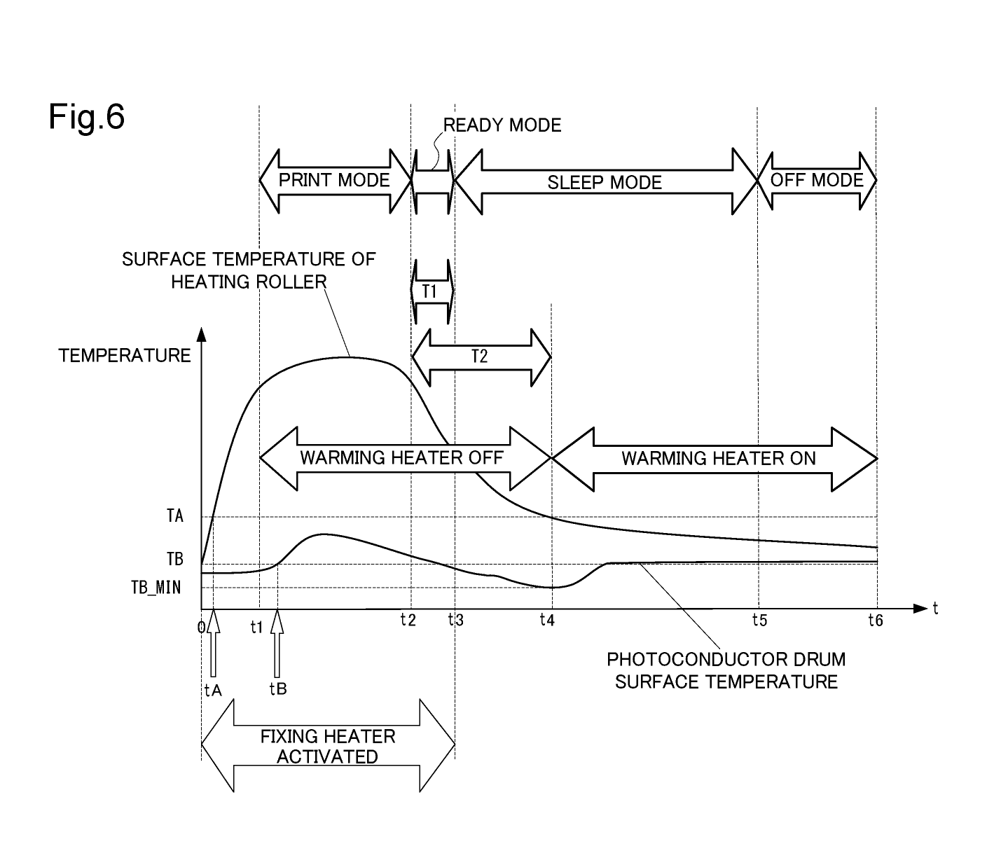

The warming heater 39 heats the photoconductor drum 121 so as to maintain the surface temperature thereof at a target temperature TB (see FIG. 6) set to 5 to 10 degrees Celsius higher than an ambient temperature. As shown in FIG. 3, the warming heater 39 is connected to the controller 100 via a warming heater driving unit 60. The roller temperature sensor 43 is connected to the controller 100. Accordingly, the controller 100 controls the warming heater driving unit 60 so as to turn on and off the power supply to the warming heater 39, on the basis of the output from the roller temperature sensor 43.

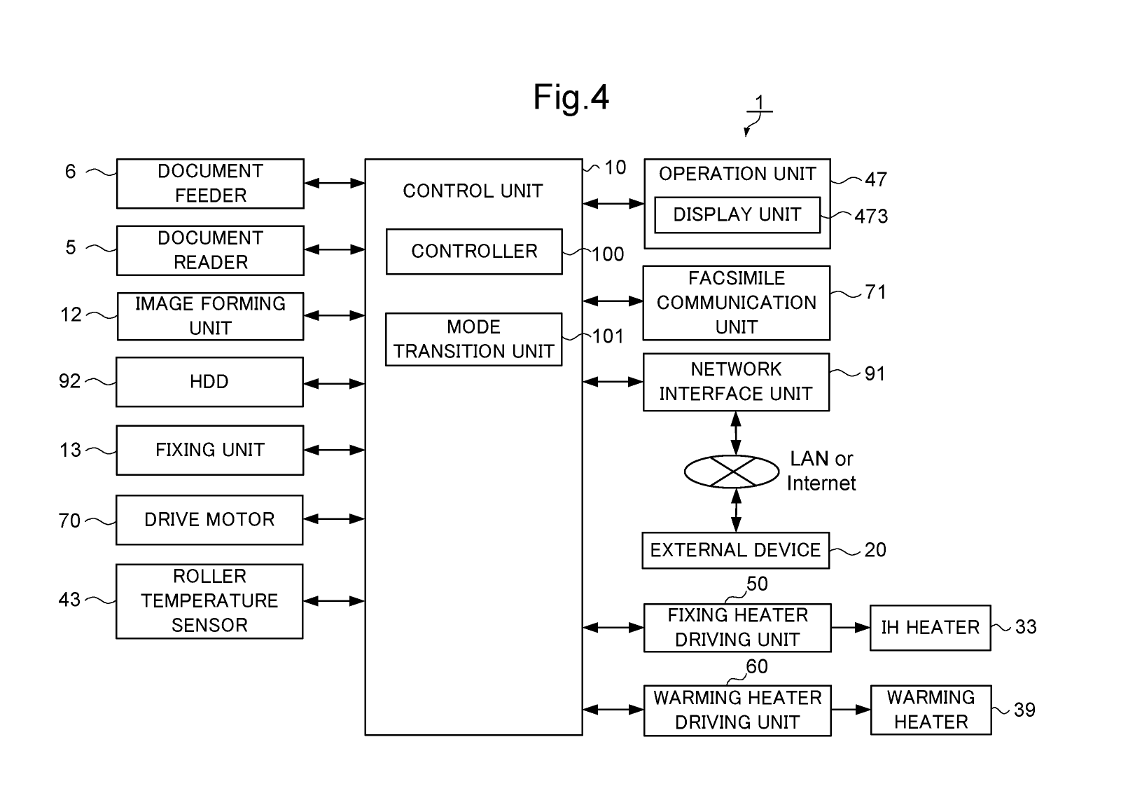

FIG. 4 is a functional block diagram showing an essential internal configuration of the image forming apparatus 1. The image forming apparatus 1 includes a control unit 10, the document reader 5, the document feeder 6, the image forming unit 12, the fixing unit 13, a roller temperature sensor 43, a fixing heater driving unit 50, a warming heater driving unit 60, the drive motor 70, the operation unit 47, a facsimile communication unit 71, a network interface unit 91, and the HDD 92. The constituents described above with reference to FIG. 1 are given the same numeral, and the description thereof will not be repeated.

The document reader 5 includes a reading mechanism 163 (see FIG. 1) including a light emitting unit and a CCD sensor, to be controlled by the controller 100 in the controller 10. The document reader 5 illuminates the source document with the light from the light emitting unit and detects the reflected light with the CCD sensor, to thereby read the image on the source document.

The HDD 92 is a large-capacity storage device for storing image data of the source document acquired by the document reader 5, and so forth.

The driving motor 70 is a drive source that provides a rotational driving force to rotational components and the transport roller pair 19 of the image forming unit 12. The fixing heater driving unit 50 is a driver circuit which, under the control of the controller 100, converts a drive voltage to be supplied to the IH heater 33, to thereby drive the IH heater 33. The warming heater driving unit 60 is a driver circuit which, under the control of the controller 100, converts a drive voltage to be supplied to the warming heater 39, to thereby drive the warming heater 39.

The facsimile communication unit 71 includes, though not shown, an encoding/decoding unit, a modem, and a network control unit (NCU), to perform facsimile transmission through a public circuit.

The network interface unit 91 includes a communication module such as a LAN board, to transmit and receive data to and from an external device 20 such as a personal computer in the local area or in the Internet, through the LAN connected to the network interface unit 91.

The control unit 10 as a processor includes a central processing unit (CPU), a RAM, a ROM, and an exclusive hardware circuit. The control unit 10 includes the controller 100 and a mode transition unit 101.

The controller 100 serves to control the overall operation of the image forming apparatus 1.

The mode transition unit 101 shifts the operation mode of the image forming apparatus 1 to a sleep mode, when a predetermined first period has elapsed after an image forming operation mode in which the image forming unit 12 forms an image is finished.

The controller 100 controls the fixing heater driving unit 50 so as to turn off the IH heater 33 when the first period has elapsed after the image forming operation mode is finished, and also controls the warming heater driving unit 60 so as to turn on the warming heater 39 when a predetermined second period longer than the first period has elapsed after the image forming operation mode is finished.

After the second period has elapsed from the time that the image forming operation mode was finished, the controller 100 controls the warming heater driving unit 60 so as to turn off the warming heater 39 in the case where the surface temperature of the heating roller 31 detected by the roller temperature sensor 43 is higher than a predetermined reference temperature, and controls the warming heater driving unit 60 so as to turn on the warming heater 39 in the case where the surface temperature detected by the roller temperature sensor 43 is equal to or lower than the predetermined reference temperature. The reference temperature corresponds to the lower limit of the temperature of the heating roller 31 that can prevent dew condensation on the surface of the photoconductor drum 121 with the heat from the heating roller 31, and is set to such a temperature that can maintain the temperature of the surface of the photoconductor drum 121 higher than an ambient temperature by 5 to 10 degrees Celsius.

The controller 100 serves to control the overall operation of the image forming apparatus 1. The controller 100 is connected to the document feeding unit 6, the document reader 5, the image forming unit 12, the fixing unit 13, the roller temperature sensor 43, the fixing heater driving unit 50, the warming heater driving unit 60, the drive motor 70, the operation unit 47, the facsimile communication unit 71, the network interface unit 91, and the HDD 92, and serves to control the operation of the cited functional units.

The control unit 10 operates in accordance with a heater control program, thereby acting as controller 100. However, the controller 100 may be constituted of hardware circuits instead of being realized by the control unit 10 in accordance with the heater control program. The same applies to other functions subsequently described, unless otherwise specifically noted.

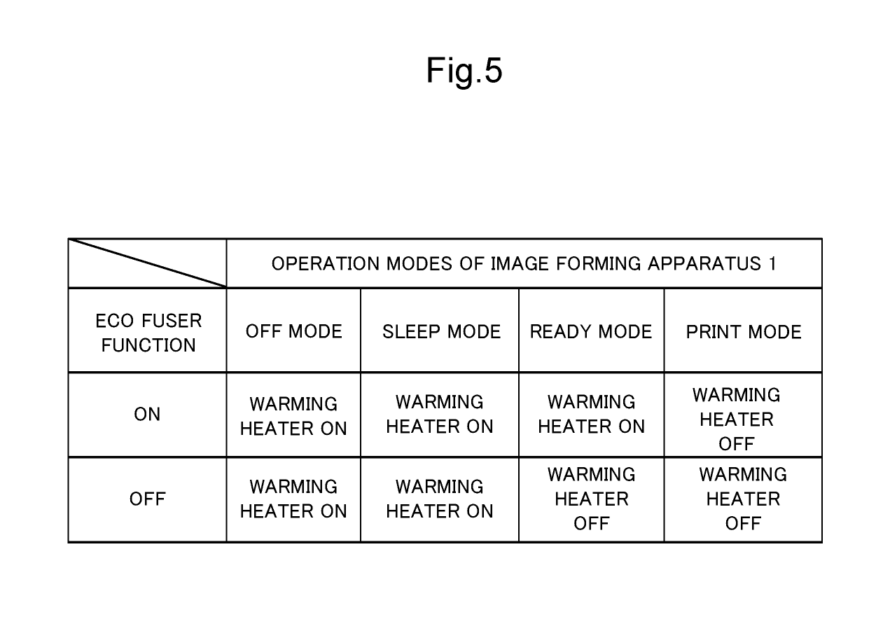

Referring to FIG. 5, a general control operation of the image forming apparatus 1 with respect to the warming heater 39 will be described hereunder.

FIG. 5 is a table showing a relationship between the on/off states of an Eco Fuser function of the image forming apparatus 1 and the on/off control of the warming heater 39.

The image forming apparatus 1 according to this embodiment is configured to perform at least the following operation modes and functions.

(1) Print mode: The image forming unit 12 is activated to perform a printing operation. In the print mode, the surface temperature of the heating roller 31 is maintained at a fixing temperature (for example, 180 to 210 degrees Celsius) that enables the fixing operation to be performed on the recording sheet P, during the image forming operation by the image forming unit 12. The image forming apparatus 1 shifts to the print mode when the operation unit 47 receives a printing instruction from an operator. The print mode exemplifies the image forming operation mode in the disclosure.

(2) Ready mode: The image forming unit 12 is in a standby state, and the image forming apparatus 1 can shift to the “print mode” in a relatively short time. In the ready mode, the surface temperature of the heating roller 31 is maintained at the temperature that enables the fixing operation (fixing temperature). The image forming apparatus 1 shifts to the ready mode, for example after the print mode is finished.

(3) Sleep mode: Power is supplied only to limited components of the image forming apparatus 1, and the remaining functions and loads are disabled or disconnected from the power supply, so as to reduce the power consumption. For example, the image forming apparatus 1 shifts to the sleep mode from the ready mode, in the case where the operation unit 47 has not received the printing instruction from the operator for a predetermined time in the ready mode.

(4) Off mode: The image forming apparatus 1 shifts to the off mode from the sleep mode, in the case where the operation unit 47 has not received any job instruction from the operator for a predetermined time in the sleep mode. The power consumption of the image forming apparatus 1 is further reduced from the power consumption of the sleep mode.

Hereunder, the drive control of the IH heater 33 by the controller 100 will be described, after which an “Eco Fuser function” incorporated in the image forming apparatus 1 will be described.

The controller 100 heats the heating roller 31 by controlling the fixing heater driving unit 50 so as to activate the IH heater 33 in the print mode. Accordingly, the surface temperature of the heating roller 31 is maintained at the fixing temperature (for example, 180 to 210 degrees Celsius) that enables the fixing operation to be performed on the recording sheet P. The controller 100 heats the heating roller 31 by controlling the fixing heater driving unit 50 so as to activate the IH heater 33 in the ready mode. By the heating in the ready mode, the surface temperature of the heating roller 31 is maintained at a level from which the fixing temperature can be reached relatively in a short time.

The “Eco Fuser function” allows the user to select whether to maintain the surface temperature of the heating roller 31 at the level from which the fixing temperature, which enables the fixing operation to be performed on the recording sheet P, can be reached relatively in a short time, when the image forming apparatus 1 is in the ready mode. When the Eco Fuser function is off, the controller 100 maintains the surface temperature of the heating roller 31 at the level from which the fixing temperature can be reached relatively in a short time (for example, 160 to 170 degrees Celsius), by controlling the fixing heater driving unit 50 so as to drive the IH heater 33. In contrast, when the Eco Fuser function is on the controller 100 controls the fixing heater driving unit 50 so as to turn off the power supply to the IH heater 33, and therefore the surface temperature of the heating roller 31 drops below the level that can reach the fixing temperature in a short time.

When the “Eco Fuser function” is off, the surface temperature of the heating roller 31 is maintained at a relatively high level such as 160 to 170 degrees Celsius, in the ready mode. Here, the photoconductor drums 121 are each located at a position exposed to the heat from the heating roller 31. Accordingly, the surface of the photoconductor drums 121 may be heated to a temperature that prevents dew condensation (for example, 5 to 10 degrees Celsius higher than an ambient temperature). In such a case, it is not necessary to heat the surface of the photoconductor drum 121 with the warming heater 39 to prevent dew condensation. In this embodiment, therefore, the controller 100 controls the warming heater driving unit 60 so as to turn the warming heater 39 on and off, for example in the ready mode.

In contrast, when the “Eco Fuser function” is on, the controller 100 controls the fixing heater driving unit 50 so as to turn off the IH heater 33 in the ready mode. Accordingly, the surface of the heating roller 31 is maintained at a relatively low temperature, for example 80 degrees Celsius. Therefore, the photoconductor drum 121 is not so much affected by the heat from the heating roller 31, and hence the heat of the heating roller 31 is not sufficient to maintain the surface temperature of the photoconductor drum 121 at the level that prevents dew condensation (for example, 5 to 10 degrees Celsius higher than an ambient temperature) on the surface of the photoconductor drum 121. In order to prevent dew condensation, the surface of the photoconductor drum 121 has to be heated by the warming heater 39. Therefore, when the “Eco Fuser function” is on the controller 100 controls the warming heater driving unit 60 so as to turn on the warming heater 39, in the ready mode.

Referring now to FIG. 6, an operation of the image forming apparatus 1 will be described hereunder.

FIG. 6 is a timing chart showing a relationship among the surface temperature of the heating roller 31, the surface temperature of the photoconductor drum 121, and time. In FIG. 6, the horizontal axis represents the time t, and the vertical axis represents the respective surface temperatures of the heating roller 31 and the photoconductor drum 121.

In this example, it will be assumed that the “Eco Fuser function” of the image forming apparatus 1 is turned off. Accordingly, the surface of the heating roller 31 is maintained at a relatively high temperature, for example 170 to 180 degrees Celsius, since the controller 100 activates the IH heater 33 while the image forming apparatus 1 is operating in the ready mode. Therefore, there is no need to heat the surface of the photoconductor drum 121 with the warming heater 39 to prevent dew condensation, and consequently the controller 100 controls the warming heater driving unit 60 so as to turn off the power supply to the warming heater 39, while the image forming apparatus 1 is operating in the ready mode.

As shown in FIG. 6, the image forming apparatus 1 operates in the “print mode” during the period from a time point t1 to a time point t2, after passing a rising period from a time the point 0 to the time point t1, and then shifts to the “ready mode” at the time point t2 where the “print mode” is finished. During a first period T1 from the time point t2 to a time point t3, the image forming apparatus 1 operates in the “ready mode”. At the time point t3 where the “ready mode” is finished, the image forming apparatus 1 shifts to the “sleep mode”. Then the image forming apparatus 1 operates in the “sleep mode” during the period from the time point t3 to a time point t5. At the time point t5 where the “sleep mode” is finished, the image forming apparatus 1 shifts to the “off mode”, and operates in the “off mode” during the period from the time point t5 to a time point t6.

During the rising period from the time point 0 to the time point t1, the controller 100 controls the fixing heater driving unit 50 so as to drive the IH heater 33, thereby heating the heating roller 31. Accordingly, the surface temperature of the heating roller 31 reaches a predetermined reference temperature TA lower than the fixing temperature, at a time point tA. After the time point tA, the controller 100 controls the fixing heater driving unit 50 so as to turn the IH heater 33 on and off, to thereby maintain the surface temperature of the heating roller 31 at the fixing temperature higher than the reference temperature TA.

While the image forming apparatus 1 is operating in the “print mode” after the rising period is over, the controller 100 heats the heating roller 31 by controlling the fixing heater driving unit 50 so as to activate the IH heater 33. Accordingly, the surface temperature of the heating roller 31 is maintained at the fixing temperature higher than the reference temperature TA. Because of this, the surface temperature of the photoconductor drum 121 also increases gradually with the heat from the heating roller 31, and reaches a target temperature TB at a time point tB. The target temperature TB is a temperature considered to prevent dew condensation on the surface of the photoconductor drum 121, and set to a temperature higher than an ambient temperature by 5 to 10 degrees Celsius.

While the image forming apparatus 1 is operating in the “ready mode”, the controller 100 controls the fixing heater driving unit 50 so as to turn on and off the power supply to the IH heater 33 on the basis of the output from the roller temperature sensor 43, thus maintaining the surface temperature of the heating roller 31 at a level higher than the reference temperature TA (for example 160 to 170 degrees Celsius). After the time point t2 where the operation mode of the image forming apparatus 1 is shifted to the “ready mode”, the surface temperature of the photoconductor drum 121 drops gradually.

When the first period T1 has elapsed after the time point t2 where the “print mode” is finished, in other words at the time point t3 where the operation mode of the image forming apparatus 1 is shifted from the “ready mode” to the “sleep mode”, the controller 100 controls the fixing heater driving unit 50 so as to turn off the power supply to the IH heater 33. Accordingly, the surface temperature of the heating roller 31 continues to drop. At a time point t4, where a second period T2 (for example, 30 minutes) longer than the first period T1 has elapsed after the time point t2 where the “print mode” is finished, the surface temperature of the heating roller 31 drops to the reference temperature TA, and continues to gradually drop after the time point t4. With the temperature drop of the surface of the heating roller 31, the surface temperature of the photoconductor drum 121 also continues to drop, and reaches a minimum temperature TB_MIN at the time point t4. Thus, the second period T2 is a predetermined period during which the surface temperature of the photoconductor drum 121 is assumed to be maintained at the temperature that prevents dew condensation, owing to the heat from the heating roller 31.

In the normal operation of the image forming apparatus 1, therefore, the controller 100 may control the warming heater driving unit 60 so as to turn on the power supply to the warming heater 39 at a time point where the surface temperature of the heating roller 31 drops to a level close to the reference temperature TA, for example at the time point t2 where the “print mode” is finished and the time point t3 where the “ready mode” is finished.

On the premise that the image forming apparatus 1 normally operates as above, the operation of the image forming apparatus 1 according to this embodiment will be further described hereunder.

After the second period T2 longer than the first period T1 has elapsed from the time point t2 where the “print mode” is finished, the controller 100 controls the warming heater driving unit 60 so as to turn on the power supply to the warming heater 39. In this embodiment, the controller 100 controls the warming heater driving unit 60 so as to turn on the power supply to the warming heater 39 when the second period T2 longer than the first period T1 has elapsed from the time point t2 where the “print mode” is finished, in other words, in this case, at the time point t4 where the surface temperature of the heating roller 31 has dropped to the reference temperature TA. Accordingly, the surface temperature of the photoconductor drum 121 can be prevented from dropping below the reference temperature TA, by heating the surface of the photoconductor drum 121 with the warming heater 39. Consequently, the surface temperature of the photoconductor drum 121 can also be maintained at the target temperature TB higher than an ambient temperature by 5 to 10 degrees Celsius.

The controller 100 according to this embodiment turns on the warming heater 39, instead of immediately at the time point where the “ready mode” is finished and the IH heater 33 is turned off as in the mentioned normal operation, at a time point later than the time point t3 by a period (T2-T1).

This is because, when the Eco Fuser function is turned off, the surface of the heating roller 31 is maintained at a relatively high temperature such as 160 to 170 degrees Celsius in the ready mode, and therefore until the period (T2-T1) elapses after the time point t3, the surface of the photoconductor drum 121 can be maintained at a temperature higher than an ambient temperature by 5 to 10 degrees Celsius so as to prevent dew condensation on the surface of the photoconductor drum 121, because of the heat from the heating roller 31, without the need for the controller 100 to immediately turn on the warming heater 39 at the time point t3 where the “ready mode” is finished.

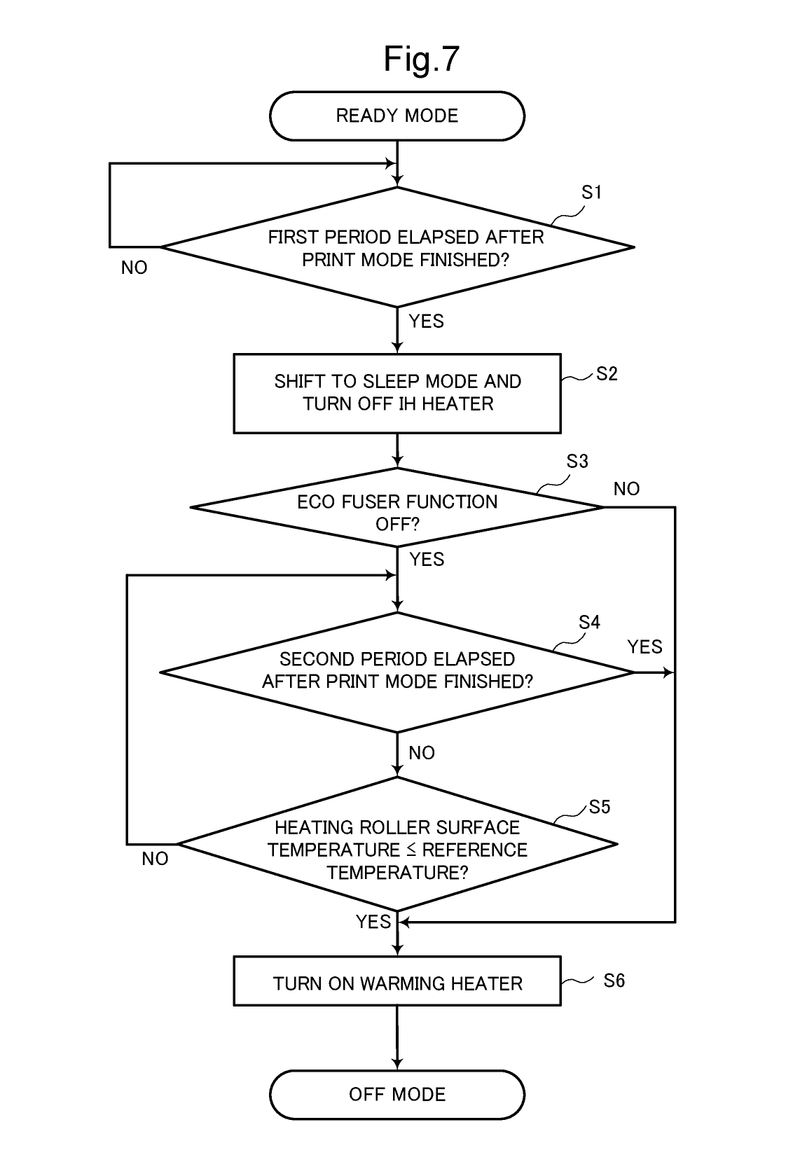

Hereunder, the on/off switching of the power supply to the warming heater 39 by the image forming apparatus 1 will be described. FIG. 7 is a flowchart showing the switching operation.

Here, it will be assumed that initially the image forming apparatus 1 is operating in the “ready mode”, and that the controller 100 is controlling the warming heater driving unit 60 so as to turn off the power supply to the warming heater 39 and controlling the fixing heater driving unit 50 so as to turn the IH heater 33 on and off thereby heating the heating roller 31, so that the surface of the heating roller 31 is maintained at a relatively high temperature such as 160 to 170 degrees Celsius.

The controller 100 decides whether the first period T1 (see FIG. 6) has elapsed after the “print mode” is finished (time point t2 in FIG. 6) (S1). In the case where the first period T1 has not elapsed after the “print mode” is finished (NO at S1), the controller 100 repeats step S1. When the first period T1 has elapsed after the “print mode” is finished (YES at S1), the mode transition unit 101 finishes the “ready mode” and shifts the operation mode of the image forming apparatus 1 to the “sleep mode”, and the controller 100 controls the fixing heater driving unit 50 so as to turn off the power supply to the IH heater 33 (S2).

The controller 100 decides whether the Eco Fuser function is off (S3). In the case where the Eco Fuser function is not off, in other words when the Eco Fuser function is on (NO at S3), the controller 100 controls the warming heater driving unit 60 so as to turn on the power supply to the warming heater 39 (S6).

In contrast, when the Eco Fuser function is off (YES at S3), the controller 100 decides whether the second period T2 (see FIG. 6) has elapsed after the “print mode” is finished (time point t2 in FIG. 6) (S4). In the case where the second period T2 has not elapsed after the “print mode” is finished (NO at S4), the controller 100 decides whether the surface temperature of the heating roller 31 detected by the roller temperature sensor 43 is equal to or lower than the reference temperature TA (see FIG. 6) (S5). In the case where the surface temperature of the heating roller 31 is higher than the reference temperature TA (NO at S5), the operation is returned to step S4. When the surface temperature of the heating roller 31 is equal to or lower than the reference temperature TA (YES at S5), the controller 100 controls the warming heater driving unit 60 so as to turn on the power supply to the warming heater 39 (S6).

Thereafter, the mode transition unit 101 finishes the “sleep mode” when a lapse of a predetermined time is detected, for example by a built-in timer provided in the control unit 10 (time point t5 in FIG. 6), and shifts the operation mode of the image forming apparatus 1 to the “off mode”.

Referring again to step S4, when the second period T2 has elapsed after the “print mode” is finished (YES at S4), the controller 100 controls the warming heater driving unit 60 so as to turn on the warming heater 39 (S6).

In this embodiment, Eco Fuser function is off the controller 100 controls the fixing heater driving unit 50 so as to turn on and off the power supply to the IH heater 33 while the image forming apparatus 1 is operating in the “ready mode”, thereby maintaining the surface of the heating roller 31 at a temperature higher than the reference temperature TA. Therefore, the surface of the photoconductor drum 121 can be maintained at a temperature that prevents dew condensation on the surface of the photoconductor drum 121 (higher than an ambient temperature by 5 to 10 degrees Celsius), because of the residual heat from the heating roller 31, without the need to immediately turn on the warming heater 39 at the time point t3 where the sleep mode is started.

Therefore, the controller 100 can turn on the warming heater 39, instead of immediately at the time point t3, where the operation mode of the image forming apparatus 1 is shifted from the “ready mode” to the “sleep mode”, at the time point later than the time point t3 by the period (T2-T1). In this embodiment, the power consumption of the warming heater 39 can be reduced by an amount corresponding to the period (T2-T1) by which the time point to turn on the warming heater 39 is delayed.

With the image forming apparatus 1 according to this embodiment, therefore, the power consumption of the warming heater 39 can be reduced, in addition to the advantage in that there is no need to additionally employ drum temperature sensors for detecting the temperature of the photoconductor drums. Consequently, dew condensation on the surface of the photoconductor drum 121 can be prevented with reduced power consumption and at a lower cost.

For example, regarding the conventional image forming apparatus A referred to earlier, the heater is constantly turned on when the operation mode is shifted from the job mode to the standby mode, and hence the energy saving effect is not sufficient. In addition, for the image forming apparatus B the environment sensor for acquitting the environment detection information has to be additionally employed, which leads to an increase in manufacturing cost. Unlike those apparatuses, the image forming apparatus 1 according to this embodiment minimizes the mentioned drawbacks.

Although the foregoing embodiment represents the case where the image forming apparatus 1 includes the photoconductor drum 121, the image forming apparatus 1 may instead include a different photosensitive body, for example a belt-type photosensitive body.

Further, the configuration and arrangement illustrated in FIG. 1 to FIG. 7 merely represent an exemplary embodiment of the disclosure, and are not intended to limit the configuration and arrangement of the disclosure.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. An image forming apparatus comprising:
an image forming unit including a photosensitive body, and configured to transfer a toner image developed from an electrostatic latent image formed on the photosensitive body on a basis of image data, and form an image on a recording sheet;
a fixing unit including a fixing heater, and located at a position downstream of the photosensitive body in a transport direction of the recording sheet so as to heat the photosensitive body with a fixing roller to which the fixing heater supplies heat, and configured to heat the toner image thereby fixing the toner image on the recording sheet;
a warming heater that heats the photosensitive body;
a fixing heater driving unit configured to turn the fixing heater on and off;
a warming heater driving unit configured to turn the warming heater on and off; and
a processor configured to: (i) control the fixing heater driving unit so as to turn off the fixing heater when a predetermined first period has elapsed after an image forming operation mode is finished, the image forming operation mode including causing the image forming unit to perform an image forming operation while the warming heater is turned off by the warming heater driving unit and the fixing heater is turned on by the fixing heater driving unit so as to heat the fixing roller; and (ii) control the warming heater driving unit so as to turn on the warming heater when a predetermined second period longer than the first period has elapsed after the image forming operation mode is finished.

2. The image forming apparatus according to claim 1, further comprising a fixing temperature sensor that detects a temperature of the fixing unit,
wherein the processor is configured to: cause the warming heater driving unit to maintain the warming heater in the off state before the second period elapses, when the temperature of the fixing unit detected by the fixing temperature sensor is higher than a predetermined reference temperature lower than the fixing temperature; and cause the warming heater driving unit to turn on the warming heater when the temperature of the fixing unit becomes equal to or lower than the reference temperature.

3. The image forming apparatus according to claim 1,
wherein the processor is configured to: perform an Eco Fuser mode including controlling the fixing heater driving unit so as to turn off the fixing heater until the first period elapses after a time point where the image forming operation mode is finished; and
cause the warming heater driving unit to turn on the warming heater when the first period has elapsed after the image forming operation mode is finished, when performing the control based on the Eco Fuser mode.

4. The image forming apparatus according to claim 1,
wherein the processor is configured to cause the warming heater driving unit to turn off the warming heater when the image forming unit starts the image forming operation.
